(19) United States
(12) Patent Application Publication
(10) Pub. No.: US 2009/0112677 A1
(43) Pub. Date: Apr. 30, 2009

(54) METHOD FOR AUTOMATICALLY DEVELOPING SUGGESTED OPTIMAL WORK SCHEDULES FROM UNSORTED GROUP AND INDIVIDUAL TASK LISTS

(76) Inventor: Randolph L. Rhett, Vallejo, CA (US)

Correspondence Address: Vierra Magen Marcus & DeNiro LLP, 575 Market Street, Suite 2500, San Francisco, CA, 94105, US

(21) Appl. No.: 12/255,432

(22) Filed: Oct. 21, 2008

Related U.S. Application Data
(60) Provisional application No. 61/000,210, filed on Oct. 24, 2007.

(51) Int. Cl. G06F 17/00

(52) U.S. Cl. 705/8

(57) ABSTRACT

A method for optimizing individual and/or group task scheduling and time management is disclosed. A scheduling application may receive a list of tasks from a user, and apply a scheduling algorithm to organize the tasks into an ordered list. Once an ordered list of tasks has been created, the scheduling application may then fit the tasks from the task list into generated time bins.

### PRIORITY CLAIM

The present invention claims priority to provisional patent application No. 61/000,210, entitled “METHOD AND SOFTWARE APPARATUS TO AUTOMATICALLY DEVELOP SUGGESTED OPTIMAL WORK SCHEDULES FROM UNSORTED GROUP AND INDIVIDUAL TASK LISTS,” by Randolph L. Rhett, which application was filed on Oct. 24, 2007, and which application is incorporated by reference herein in its entirety.

### BACKGROUND OF THE INVENTION

1. Field of the Invention

The present invention relates to a method for optimizing individual and/or group task scheduling and time management.

2. Description of the Related Art

It has long been the state of the art in time management to first develop a list of all tasks, or critical steps, required to complete a project or goal. The tasks from multiple projects are usually then combined into a master list. The tasks on the master list are prioritized, one by one, thereby creating a theoretical order for the completion of each task. On a regular basis, usually daily, an individual is encouraged to review the priority of the entire list and re-assign priority for each task on the list. Furthermore, the individual is encouraged to select those items from the list with the highest priority which can be accomplished that day and create a sub-list of daily tasks. Additionally, individuals are encouraged to view their available time and set aside certain segments of time for certain categories of tasks. For example, to be assured that one does not neglect time for following up on current sales leads, one is encouraged to set aside an hour every morning for specific tasks related to following up on current sales leads.

The problem with this system is that it requires near constant maintenance. Every day the individual must re-evaluate the relative priorities of the tasks on the master list. He or she must calculate the impact of choosing to complete one task over the other. To further complicate matters, the impact of choosing one task over another may also impact the timely achievement of other projects on the master task list. If, as is usually suggested, the individual's schedule is further fractured by time segments assigned to specific categories of tasks, the entire process becomes significantly more complex. Finally, an unexpected interruption, for example, a new meeting subsequently scheduled, render decisions made at the beginning of a day obsolete, and new analysis is required.

Unfortunately, for most people, the maintenance required on such a system is unworkable. A person with five or six projects, each with a dozen or more tasks, literally would have thousands of permutations to consider. A project manager who shares workers with other project managers may literally face millions of permutations in assigning tasks to team members. As a result, most abandon any systematic system for scheduling and react, at best, to the problem heuristically. The result is inefficiency, missed deadlines, over commitment, and the perpetual problem of project managers assigning tasks to workers that compete with tasks assigned by other managers.

Previously, software developers created tools that assisted the user in performing these calculations manually. The most basic of them permit the creation of simple lists of tasks with priorities assigned manually. The best known example is Microsoft's Outlook.

Outlook permits the user to enter pending tasks into a list. The individual tasks may then be assigned a priority and/or a due date. Finally, the list may be sorted by either priority or due date. No further assistance is provided by the program in determining the best use of one's time.

In reality, few people use such lists because they quickly become stale. A flat list with manually entered priorities ignores the fact that priorities change over time. A task that is due in six months may have a low priority today. However, in five months and twenty-nine days it may have extremely high priority. Furthermore, a list of dozens, if not hundreds, of identical looking tasks becomes visually overwhelming. Such a list discourages the kind of thorough daily review required to keep a task list from becoming stale. Others, like Franklin-Covey, allow the user to pull individual items from a master task list manually into a more manageable daily task list. Nonetheless, this still requires the individual to conduct an analysis of what should pass to the daily list from the master list. Finally, some users combine the Calendar portion of programs like Outlook and the task list to attempt setting aside segments of time for categories of tasks. Again, this process is cumbersome and still leaves the analysis to the user. Such a system requires the user to scan each task in the task list, seek only those tasks that match the category to which a segment of time is assigned, and prioritize between just those tasks from the list. No automatic scheduling of tasks is offered by any of the prior art.

### SUMMARY

Embodiments of the present invention relate to a method for optimizing individual or group task scheduling and time management. In embodiments, a scheduling application may receive a list of tasks from a user, and then apply a sorting algorithm to organize the tasks into an ordered list. The scheduling application may for example use the “Least Slack Time” algorithm to order a user's tasks. Once an ordered list of tasks has been created, the scheduling application may then fit the tasks from the task list into generated list of empty “bins” of time in the user's schedule. Embodiments of the present invention may use a “First Fit First” algorithm to schedule individual tasks into the empty “bins” of available time. In such embodiments, the algorithm looks at the available space in each successive time bin, and schedules a task in the first time bin large enough for the task. Once the optimized suggested work schedule is generated, it may be displayed over a graphical user interface to the user.

In further embodiments, it is contemplated that certain time segments (i.e., a group of one or more time bins) may be classified in different categories, and certain tasks may then be assigned to specific categories. In such embodiments, the scheduling application generates from an availability template available time bins within each of the category time segments, if any. The algorithm then assigns different tasks to different time blocks, with each task being assigned to its specified time block category. In still further embodiments, the present invention may be used for task scheduling and management in a group environment. In such an embodiment, the scheduling application considers the schedules of all group members, and optimizes the breakdown of tasks among the group as a whole.

### BRIEF DESCRIPTION OF THE DRAWINGS

FIG. 1 depicts a system architecture of an embodiment of the present invention for optimizing time and task management.

FIG. 2 depicts a flowchart of an embodiment for generating a master task list for an individual user.

FIG. 3 depicts a flowchart of an embodiment for generating a work schedule from an ordered list.

FIG. 4 depicts a flowchart of an embodiment of how the system schedules tasks that have been categorized into specific category time segments.

FIGS. 5A and 5B together depict a flowchart of an embodiment of group scheduling of a project, including an optional mechanism for preventing any one group member from carrying a disproportional load of the group's tasks.

FIG. 6 is a block diagram of a computing system capable of implementing embodiments of the present invention.

### DETAILED DESCRIPTION

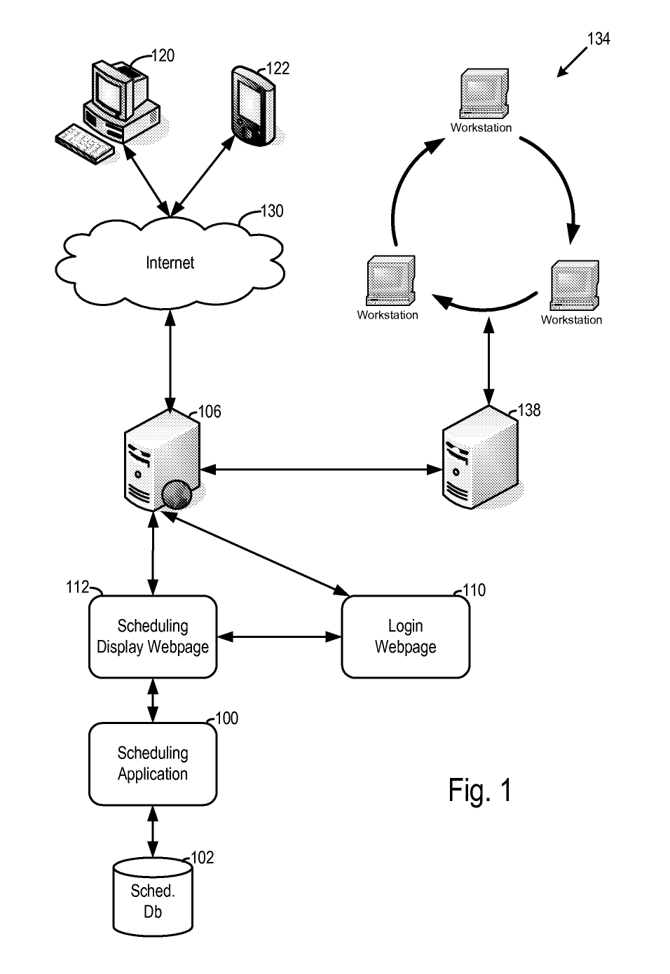

Embodiments of the present invention will now be described with reference to FIGS. 1-6, which in general relate to a computer-based application that uses advanced algorithms to apply artificial intelligence to the user's master task list. The application performs an analysis of all tasks to be performed and develops workable schedules from a task list.

FIG. 1 shows a system architecture for the operation of an embodiment of the present invention. A scheduling application 100, the operation of which is explained hereinafter, generates a suggested optimized time and task management schedule. The schedule is stored in a scheduling database 102 along with other scheduling and user profile information. Database 102 may store scheduling information for all users of the scheduling application 100.

In embodiments, the scheduling application 100 and database 102 may be stored on a web server 106 (or stored on a computer linked to web server 106) to allow a user to access the scheduling application 100 via a web browser from different remote locations. Instead of, or in addition to, storing the application 100 and database 102 on a remotely accessible web server, it is understood that the application 100 and database 102 may be stored on a local computer (120) or other computing device (122). In such an embodiment, the application 100 could be run by a user over his/her local computer without the aid of a browser. For web-based use, web server 106 may include a login webpage 110 for authenticating users. Web server 106 may further include one or more scheduling display webpages 112, which, upon proper user authentication, present users with a graphical user interface allowing users to view their optimized schedule and provide task and scheduling input to the scheduling application 100.

In embodiments, a user may access the web server 106 and the scheduling application 100 from a remote computer 120 or other computing device 122, which may for example be a personal digital assistant or smart phone. The computer 120 or computing device 122 may access web server 106 via the Internet 130, or some other network such as a LAN.

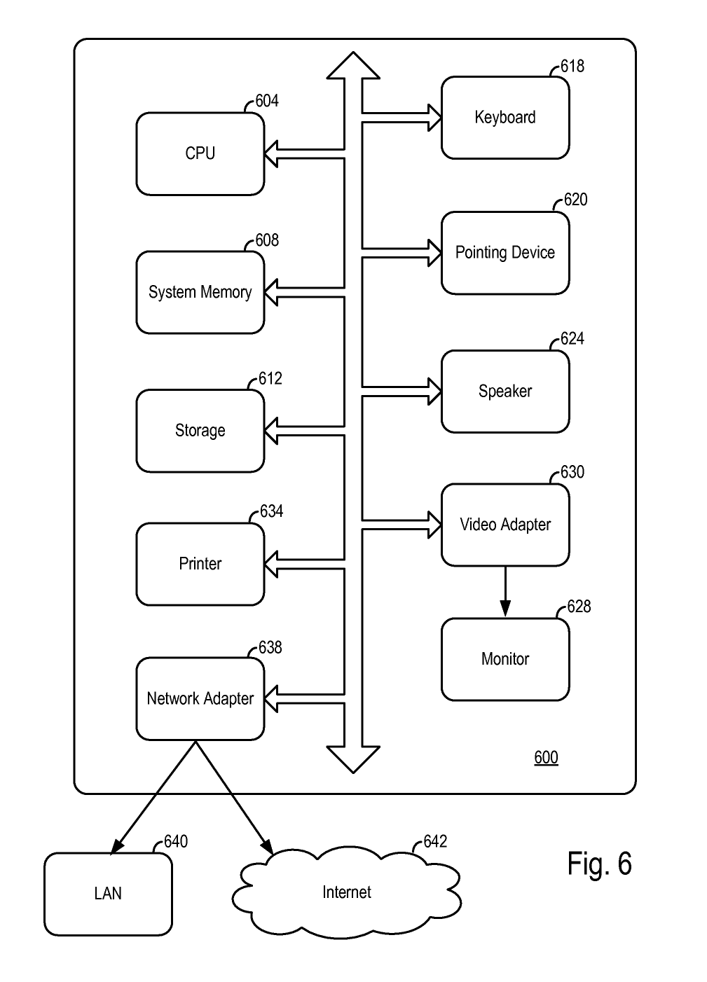

As explained hereinafter, embodiments of the present invention may be used to optimize scheduling and task management among a group of people, such as co-workers in an office setting. Accordingly, web server 106 may also be accessed by an office network of computers 134 via an office server 138. As above, it is understood that the application 100 and database 102 may be stored locally on the office server 138, where it may be accessed by the office network of computers 134. Those of skill in the art will appreciate a variety of other system architectures for implementation of embodiments of the present invention. With regard to the computer architectures of web server 106, office server 138, computers 120 and 134, and computing device 122, a sample computer architecture for these devices is set forth below with respect to FIG. 6.

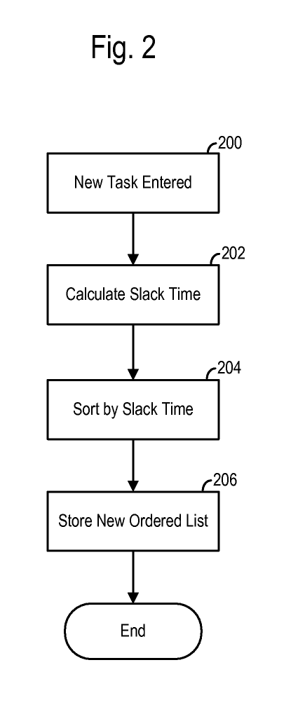

The operation of embodiments of the scheduling application 100 will now be described with respect to the flowcharts of FIGS. 2 through 5B. Referring initially to FIG. 2, in step 200, a user may input all of the tasks that the user needs to perform, for example via the scheduling display webpage 112. As explained hereinafter, the user may also define different category time segments, each for a different category of tasks (e.g., work, family, leisure, etc.). In steps 202-204, the application may apply a scheduling algorithm to perform a master sorting of the entire list. While many existing algorithms may work, in one embodiment, the application uses the “Least Slack Time” (“LST”) algorithm. In step 202, slack time for the different tasks is calculated, and in step 204, using an LST algorithm, the application sorts the individual tasks by their due date less the time to complete the tasks. The items that have the least slack time at the time of sorting will have the highest priority, and those with the most slack time will have the lowest. The resulting ordered list may be stored in database 102 in step 206.

Slack time is the closest analog to how most people sense urgency in the completion of tasks, and embodiments of the present invention assume all deadlines are equally important.

Because a user may manually shift a deadline, if necessary, to accurately reflect the relative importance of two conflicting deadlines, it is not necessary to include a system of weighted deadlines. However, if such a feature were required, it would easily be added to an embodiment by allowing the user to artificially shrink the slack time for items with relatively more pressing deadlines. Likewise the system can be made to swap past due items of high deadline priority with earlier scheduled items with low deadline priority.

Furthermore, embodiments of the present invention assume no ordering of the tasks. Such ordering, for example tasks that may not be scheduled until after some other task is completed, is possible in alternative embodiments by employing any of a number of existing scheduling algorithms and modifications to the Least Slack Time algorithm. Finally, the user may impose an ordering of tasks manually and override the automatic system at any time. The user may also combine manual ordering of a partial list with automatic scheduling. Use of other scheduling algorithms, or a combination of manual and automatic ordering, is contemplated in further embodiments.

This ordering pass is done automatically by the computer as often as the user pleases. In embodiments, the list is sorted once daily and any time an addition, deletion or modification of the list is made. The thousands of calculations that are so onerous to individuals are done in fractions of a second by the computer thus ensuring realistic and up to date prioritizing of a master list without the required analysis and maintenance of the current state of the art.

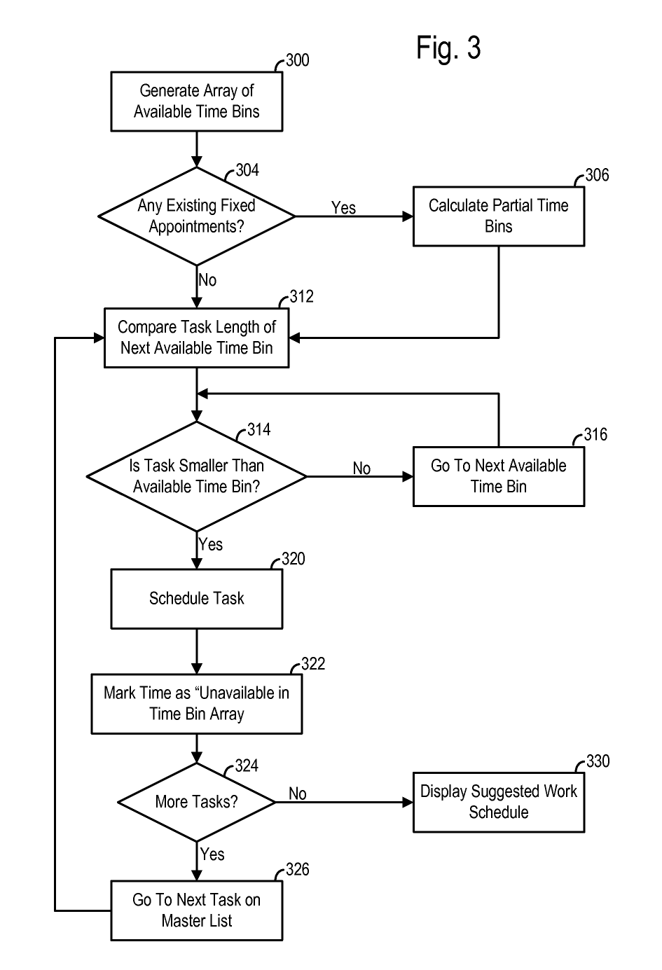

Referring now to the flowchart of FIG. 3, once the master list is ordered, the application then generates an optimized schedule for performing the user's tasks. The application 100 uses a “Bin Packing” algorithm to find time in the user's schedule for the now sorted tasks. The concept requires that one visualize available time as physical bins and tasks as objects of a certain size that must fit into the bins. A given time bin is an uninterrupted available block of time associated with specific days in a user's schedule. The size of the bin becomes a stand-in for available time and the order of the bin for days in a calendar. Tasks are assigned sizes by the user to represent the estimated time to complete the task. Next, the application 100 generates an array of available time bins in step 300. In embodiments, these time bins may default to one hour time blocks during waking hours in a day unless otherwise configured by a user. For example, if one has not characterized his or her time in any way, but is awake 16 hours a day, his or her available time may appear as an endless series of 16 hour bins arranged in chronological order.

It may generally be the case that a user would not define his or her time bins in solely one hour time blocks. The bins may be longer, or it may happen that not all time bins are defined as being the same size. For example, if a user's work day is 8:30 am to 12:30, then lunch, then 1:30 pm to 6:30 pm, the user's availability template would look like an endless alternating series of 4 hour bins followed by 5 hour bins, each set associated with a particular day in the future.

In step 304, the application checks whether there are any fixed appointments. In particular, a user will typically have appointments scheduled for fixed times, which appointments are manually entered by the user. Fixed appointments are scheduled as desired by the user regardless of time bin definitions or category time segments (described below). If there are fixed appointments, the application calculates partial time bin(s) during which that appointment is scheduled. That is, an appointment may occur completely within a given time bin. If so, the time within that time bin is reduced, and one or more tasks are scheduled within that partial time bin only if the time remaining within the partial time bin is large enough to accommodate the one or more tasks. Likewise, an appointment may span two or more time bins. If there is a partial time bin at the start of the appointment, or partial time bin at the completion of the appointment, task(s) may be scheduled within those partial time bins provided there is sufficient time within those partial time bins to accommodate the task(s).

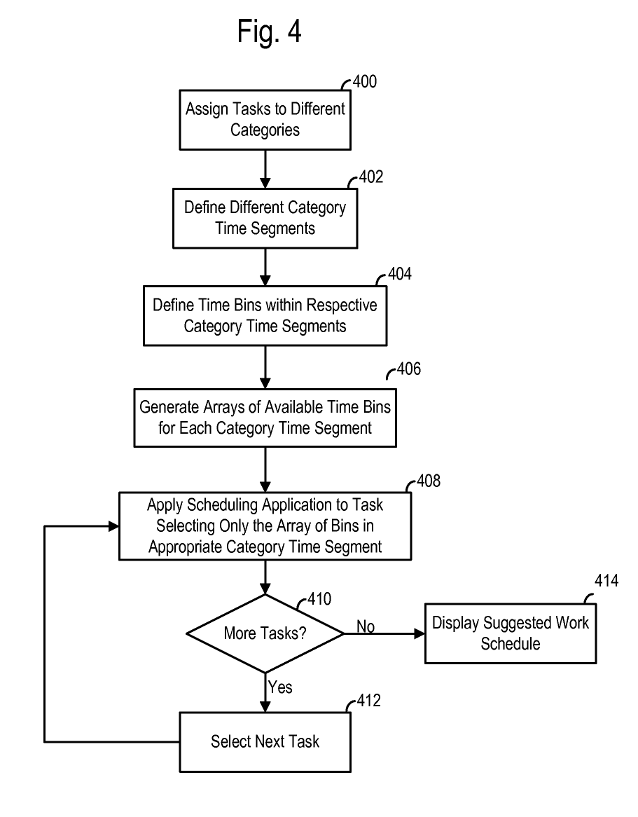

Once the list of available time bins has been compiled, the application 100 then fits the tasks from the task list into the time bins. Embodiments of the present invention apply the “First Fit First” (FFF) algorithm as it is the best at preserving the original order of the master list. The FFF algorithm simply looks at the available space in each bin, in the order that the bins appear, and schedules the task in the first bin (or partial bin) large enough for the task. In particular, in step 312, the application takes a task, and compares the task length to the next available time bin. In step 314, the application checks whether the duration of the current task under consideration is smaller than the next available time bin. If the task is larger than the time bin, the application proceeds to the next available time bin in step 316, and returns to step 312 to see if the next time bin will accommodate the current task. Once a time bin is found that will accommodate the current task, the task is scheduled for that time bin in step 320. The above does not mention different category tasks, but as described below with respect to FIG. 4, to the extent different categories of tasks and different category time segments are defined, tasks will be assigned according to the FFF algorithm while preserving the proper categorization of tasks.

A task need not fill a bin entirely. Assume for example a Monday has a 4 hour bin of available time and a 5 hour bin of time. The 4 hour bin may get filled by a one hour task, followed by a two hour task. If the following task to by assigned by the system is more than one hour (so as to exceed the 4 hours allotted to the instant time bin), it will not be placed partially within the 4 hour bin. It will be placed in the following 5 hour time bin (assuming there is sufficient time in that bin). In embodiments, while manually added appointments can fill more than one bin, tasks do not. A task will be placed in the first bin that has enough time to handle the entire estimated time for the task.

In embodiments, it is understood that a given task may be broken down into definable component parts. If so, some component parts of a task may be placed in a first available time bin, and other component parts placed in the next available time bin. In the event a more tightly packed schedule is required, a more efficient packing algorithm such as “Best Fit First” (BFF) can be substituted for the FFF algorithm in alternative embodiments.

Once the current task is assigned to a time bin in step 320, that time bin is marked unavailable in step 322. In step 324, the application checks whether there are more tasks on the master list of ordered tasks. If so, the application retrieves the next task in step 326 and returns to step 312 to assign that next task to the next time bin that is big enough to accommodate it. On the other hand, if in step 324 it is determined that all of the tasks on the master list have been assigned to time bins, the optimized suggested work schedule may be displayed to the user over webpage 112 in step 330.

FIG. 4 illustrates a further embodiment of the present invention, where the packing algorithm of the application can be run on any series of time bins in different category time segments. In particular, in user's daily life, he or she will generally categorize their time for different tasks. For example, a user may break down their weekdays as 8:30 am to 12:30 pm and 1:30 pm to 6:30 pm as two bins devoted to work tasks, a user may then devote 7:30 pm to 9:30 pm, as well as part of the weekend, as time bins devoted to family tasks, and 9:30 pm to 10:30 pm, and part of the weekend, as time bins devoted to leisure tasks. These different categories of time are referred to herein as different category time segments. The category time segments set forth above are by way of example, and the user is free to create whatever and however many different categories as desired.

Referring now to FIG. 4, in step 400, a user can assign different tasks to different categories (this may occur via the scheduling display web pages 112, and may occur at the same time the tasks are created or after the tasks are created). In step 402, a user may define different category time segments (again, via the scheduling display web pages 112). Each category time segment may include one or more time bins. Thus, in step 404, a user may define one or more time bins within respective category time segments. If no time bins are created within a category time segment, the category time segment may be treated as having a single time bin spanning the length of the category time segment. From the information received in steps 400-404, the system generates an availability template in step 406 which is a master chart of availability within which tasks from the different categories may be assigned.

Next, in step 408, the application fits the tasks into available time bins, using for example the process described above with respect to FIG. 3. When the system schedules a task as explained above, the system will only schedule a task from a given category within the category time segment for that category. The task from a given category will be assigned within the first time bin in the associated category time segment large enough to accommodate the task. Note in the above example including categories for work, family and leisure, no time category was created between the hours 10:30 pm and 8:30 am (as a user may use this time for sleep). As long as a user properly categorizes his or her tasks, the system will automatically prevent any tasks from being scheduled during this time period. After a task is assigned to a time bin, that time bin, or portion thereof, is then marked unavailable.

After a task has been assigned to a particular time block in step 408, the application next checks whether there are more tasks on the list of ordered tasks in step 410. If so, the application retrieves the next task in step 412 and returns to step 408 to assign that next task to the next time bin, or unused portion thereof, big enough to accommodate it (in the appropriate category time segment if applicable). On the other hand, if in step 410 it is determined that all of the tasks on the list have been assigned to time bins, the optimized suggested work schedule may be displayed to the user over webpage 112 in step 414.

Although not shown in FIG. 4, it is understood that a user may schedule fixed appointments as desired. Fixed appointments may be placed in any time bin in any category time segment, and fixed appointments may span different time bins and/or category time segments. After manual entry of fixed appointments, the size of the available time bins in the different category time segments is adjusted accordingly.

In any of the above-described embodiments, the process may be run, automatically, once per day (or at some other fixed time interval). The process may alternatively run in real time, each time some triggering event occurs. Thus, a user's schedule may be recalculated and updated whenever a new task is created, whenever a task is completed, and whenever there is a change in the schedule (such as the creation of a new fixed appointment). Additionally, a user's schedule may be recalculated and updated in real time when the scheduled time for completion of a given task comes and goes, and the task is not marked as being completed.

In the event a task is added or missed, the application would reschedule the task (referred to below as task A) to the next time bin large enough to accommodate it (within a given category if applicable). The next time bin may already have a task (referred to below as task B). However, if task A is a higher priority than task B, for example according to the least slack time algorithm, then task B is bumped from its time bin and task A is scheduled in that time bin. Task B is then rescheduled, which may bump another task, and so on. Thus, any time a new task or appointment is added, or if a scheduled task is not marked off after its scheduled time, this may generate a ripple effect, where down stream tasks get rescheduled to preserve the least slack time and first fit first ordering of tasks. In alternative embodiments, a user may set the system to reschedule tasks that are added or missed at a location that will not require reordering of other tasks.

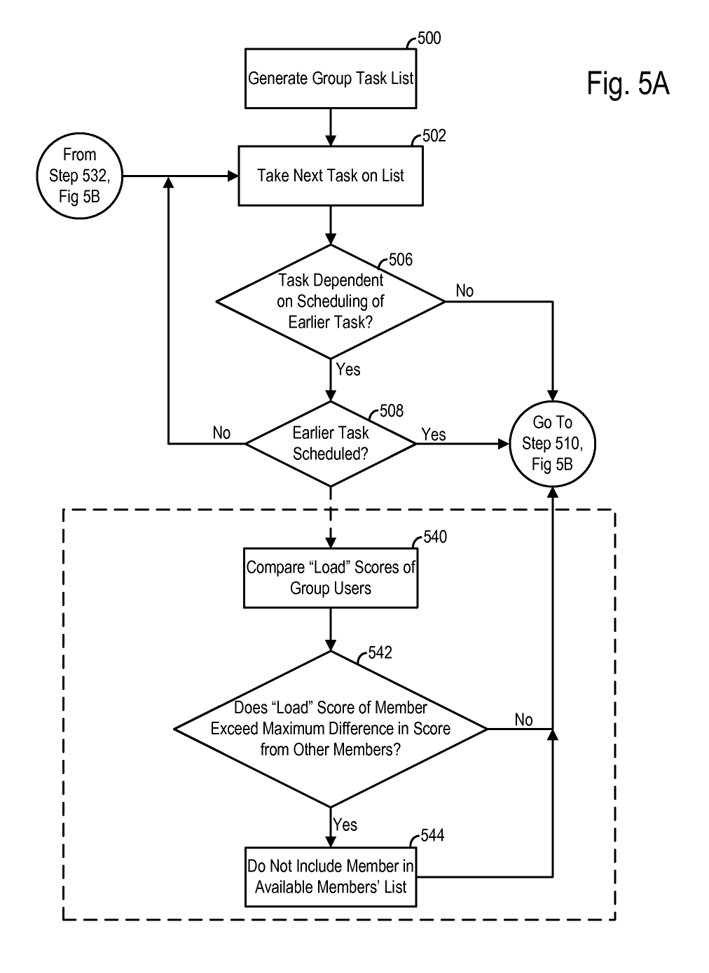

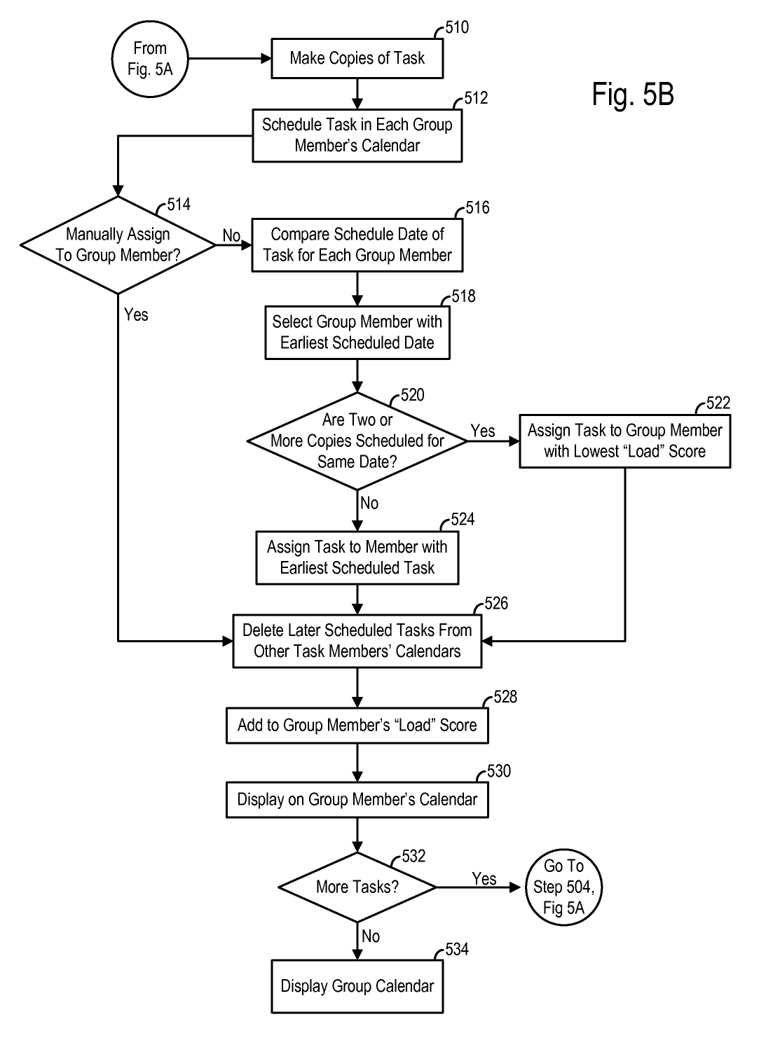

FIGS. 5A and 5B relate to a method of generating and optimizing task scheduling and management in a group environment. In the group scheduling environment, the group generates a list of tasks required to complete the project in step 500. This list is ordered automatically by the system's scheduling algorithms (for example by least slack time), or the group might impose an order, or any combination thereof. Once ordered, the application applies the bin packing algorithm to the schedules of all the members for each task. In particular, in step 502, the first/next task is retrieved. In embodiments, it may happen that one or more tasks need to be performed before one or more other tasks. This may be designated when setting up the task list by setting a second task to be dependent on a first task, meaning the first task needs to be scheduled and performed prior to the second task. In step 506, the system checks whether the current task is dependent on another task. If not, then the system proceeds to step 510 (FIG. 5B). On the other hand, if the current task is dependent on another task, the system checks whether the other task has been scheduled yet in step 508. If so, the current task may be scheduled, and the system proceeds to step 510 (FIG. 5B). On the other hand, if the other task has not yet been scheduled, the task remains on the list of tasks to be scheduled, and the system returns to step 502 to schedule the next task on the list. It is understood that this feature may also be applied in the individual user context described above with respect to FIGS. 2-4.

Steps 510-530 (FIG. 5B) relate to scheduling of events on respective group members' calendars. In step 510, multiple copies of each task are created, one for each member in the group. The tasks are then scheduled into each group member's individual schedule in step 512 in the identical manner as individual tasks are scheduled for a lone user. In embodiments, it may be possible for group members or a manager to manually assign a given task to a given group member. Accordingly, in step 514, the system checks for a manual assignment. If the current task has been manually assigned, the system skips down to step 526 as described hereinafter.

Assuming the task has not been manually assigned to a given group member, the application may assign the copies of the task different times for the different group members, depending on the different group members' schedules. The system then compares the schedule date for the task against the schedules of each group member in step 516, and next selects the member whose schedule permitted the earliest scheduling of that task in step 518.

To avoid unbalanced distribution of group tasks, the assignment of each task can include a “load” value in embodiments of the present invention. In such embodiments, upon assignment of a task, the task's “load” value is added to the individual member's total “load.” In step 520, the application may check if two or more copies of the current task are scheduled for the same date (two group members have that task assigned to the same time). If so, the task is assigned to the group member with the lowest load score in step 522. If there are no copies of the current task scheduled for the same date (or in embodiments not factoring in load), then the task is simply assigned to the group member able to perform the task at the earliest date.

In step 526, the task is then deleted from the schedule of the other group members. In embodiments factoring in load, the load value for the group member to whom the current task is assigned is incremented (step 528), and the task is displayed on the group member's calendar (step 530). The application next checks whether there are more tasks on the master list of ordered tasks in step 532. If so, the application returns to step 502 (FIG. 5A) and retrieves the next task. On the other hand, if in step 532 it is determined that all of the tasks on the master list have been assigned, the group calendar is then displayed with assignment and scheduling of all tasks among group members being displayed.

As indicated above, in embodiments, individual members' loads may be considered in distributing tasks. In such embodiments, upon assignment of a task, the task's “load” value is added to the individual member's total “load.” This aspect is shown in steps 540-544 (FIG. 5A). In step 540, the application compares all load scores of the group members. In step 542, if an individual's total “load” is determined to exceed a user defined amount, or exceeds a maximum difference relative to other group members' “load” value, the system will eliminate that user from consideration in step 544 for the purpose of scheduling the next task. The application then proceeds to step 510 (FIG. 5B) as described above to schedule tasks. The member will not be considered for another task until the “load” value is again within pre-defined limits. If no member of the group has more than the maximum load value beyond the load value that the others have, then the application may simply proceed from step 542 to step 510. Steps 540-544 are shown within a dashed box as they are optional and may be omitted in embodiments. Steps 520, 522 and 528, similarly relating to load as described above, may also be omitted. It is also contemplated in further embodiments that users may assign time bins and/or category time segments, as described above, to define time in their schedules which they are willing to devote to the group's tasks.

Embodiments of the system described above allow individual users and a group of users in a group environment to optimize a schedule for performing a group of tasks. The above system also allows individual users, and group users and managers in a group environment, to optimize management of task scheduling. As tasks are automatically pushed out and rescheduled if not performed by a scheduled time, a user/manager can quickly and easily see which tasks are getting performed and which tasks are not. For example, in a group environment, if users or a manager see that a given individual is not performing tasks on schedule, this will be readily apparent with the present system, and the users/managers then have the ability to take action including reassigning delinquently performed tasks to others within the group. This prevents bottlenecks, missed deadlines, and optimizes completion of the tasks as a whole.

FIG. 6 shows a block diagram of a suitable general computer 600 capable of executing embodiments of the application of the present invention. Examples of well known computing systems that may be suitable for use with the present invention include personal computers, server computers, multiprocessor systems, microprocessor-based systems, personal digital assistants, smart mobile phones, network PCs, minicomputers, mainframe computers, and other computing systems.

The present system may be described in the general context of computer-executable instructions, such as program modules, being executed by a computer. Generally, program modules include routines, programs, objects, components, data structures, etc., that perform particular tasks or implement particular abstract data types. With reference to FIG. 6, there is shown a computer 600 capable of performing the executable instructions of the present invention. Components of computer 600 may include, but are not limited to, a processing unit 604, a system memory 608, and a system bus 610 that couples various system components including the system memory to the processing unit 604.

The system memory 608 includes computer storage media in the form of volatile and/or nonvolatile memory such as for example read only memory (ROM) and random access memory (RAM). The system bus 610 may be any of several types of bus structures including a memory bus or memory controller, a peripheral bus, and a local bus using any of a variety of bus architectures.

Computer 600 may further include storage 612, which may be any of a variety of storage media including for example a hard disk drive, flash memory or other memory technology, CD-ROM, digital versatile disk (DVD) or other optical disk storage, magnetic cassette and/or magnetic tape.

A user may input data into the computer 600 via input devices such as a keyboard 618 and pointing device 620, commonly referred to as a mouse, trackball or touch pad. Other input devices (not shown) may be included. Data and other information may be output from the computer 600 via speaker 624 and monitor 628 (or some other type of display). The monitor may connect with the system bus 610 via an interface such as video adapter 630. A variety of peripheral devices may also be connected to computer 600, such as printer 634.

As discussed above, the computer 600 may operate in a networked environment to communicate with any of a variety of other networked devices. Such communication may be accomplished via network adapter 638, which is capable of connecting to a local area network (LAN) 640, the Internet 642 or any of a variety of other networked environments.

Those of skill in the art will appreciate that computer 600 may include a wide variety of additional and/or alternative components in further embodiments.

The present system allows project managers and other individuals to have optimized schedules generated automatically for him or her. A project manager can now instantly compare thousands of tasks to the availability of dozens of workers who may be working in parallel on several other projects. The system will give the project manager, as well as the individual, instant feedback as to whether a project is falling behind, whether the individual is overcommitted, whether there is under-utilized time, and whether goals can be met.

The foregoing detailed description of the inventive system has been presented for purposes of illustration and description. It is not intended to be exhaustive or to limit the inventive system to the precise form disclosed. Many modifications and variations are possible in light of the above teaching. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

I claim:

1. A computer implemented method for optimizing scheduling of tasks, comprising the steps of:
a) receiving from a user a set of tasks, a deadline for each task in the set of tasks and an approximation of the time to perform each task in the set of tasks;
b) determining a slack time for each task, the slack time for a task being the time from the current time to the deadline for the task, minus the approximation of the time to perform the task;
c) ordering the set of tasks in an ordered list from those having the least slack time to those having the most slack time;
d) generating a plurality of time bins representing a user's available time going forward;
e) generating a schedule for performing the set of tasks by fitting the tasks from the ordered list generated in the step c) into the time bins generated in the step d), beginning with the first task on the ordered list and proceeding successively through the ordered list until each task is fit within a time bin, with each task being fit within the first time bin, or unused portion thereof, large enough to accommodate the task based on the approximate length of the time to perform the task;
f) designating a portion of the time bin into which a task is fit as unavailable to receive additional tasks; and
g) displaying the schedule of tasks generated in the step e).

2. The method of claim 1, further comprising the step of receiving one or more fixed appointments scheduled for a fixed time and duration, and removing the fixed time and duration from time bins generated in said the step d).

3. The method of claim 2, wherein said step of receiving one or more fixed appointments shortening the length of one or more time bins during which the appointment is to occur, said shortening of the length of one or more time bins possibly requiring reshuffling of one or more tasks into time bins per said step e).

4. The method of claim 1, further comprising dividing a user's available time into one or more category time segments, each category time segment divided into one or more time bins.

5. The method of claim 4, further comprising the steps of generating a schedule for performing the set of tasks in a particular category by fitting the tasks for that category from the ordered list into the time bins for the category time segment specified for that category, beginning with the first task on the ordered list in that category and proceeding successively through the ordered list of additional tasks in that category until each task in that category is fit within a time bin in that category time segment, with each task being fit within the first time bin large enough to accommodate the task based on the approximate of the time to perform the task.

6. The method of claim 1, further comprising the step of automatically updating the schedule generated in the step e) at least once a day based on fixed appointments or tasks added or deleted by the user, or by a user not performing a task at its scheduled time.

7. The method of claim 1, further comprising the step of automatically updating the schedule generated in the step e) in real time based on fixed appointments or tasks added or deleted by the user, or by a user not performing a task at its scheduled time.

8. The method of claim 1, wherein a user is capable of adding, deleting or changing task and fixed appointment data from any of a variety of locations by accessing a web page on a remote web server.

9. A computer implemented method for optimizing scheduling of tasks between a group of users sharing responsibility for accomplishing the tasks, the method comprising the steps of:
a) receiving from one or more group users a set of tasks, a deadline for each task in the set of tasks and an approximation of the time to perform each task in the set of tasks;
b) determining a slack time for each task, the slack time for a task being the time from the current time to the deadline for the task, minus the approximation of the time to perform the task;
c) ordering the set of tasks in an ordered list from those having the least slack time to those having the most slack time;
d) generating a plurality of time bins, representing a user's available time going forward, for each user in the group;
e) generating a group schedule by assigning each task in the set of tasks successively from the ordered list to users in the group, a task being assigned to the group user who has the first time bin, or unused portion thereof, large enough to accommodate the task based on the approximate of the time to perform the task and based on the respective schedules of the group users;
f) designating a portion of the time bin on the group user's schedule into which a task is fit as unavailable to receive additional tasks; and
g) displaying the group schedule of tasks generated in the step e) to the group.

10. The method of claim 9, further comprising the step of receiving, from one or more users, one or more fixed appointments scheduled for a fixed time and duration, and removing the fixed time and duration from that user's time bins generated in said the step d).

11. The method of claim 9, wherein a user is capable of adding, deleting or changing task and fixed appointment data from any of a variety of locations by accessing a web page on a remote web server.

12. A computer implemented method for optimizing scheduling of tasks between a group of users sharing responsibility for accomplishing the tasks, the method comprising the steps of:
a) receiving from one or more group users a set of tasks, a deadline for each task in the set of tasks and an approximation of the time to perform each task in the set of tasks;
b) determining a slack time for each task, the slack time for a task being the time from the current time to the deadline for the task, minus the approximation of the time to perform the task;
c) ordering the set of tasks in an ordered list from those having the least slack time to those having the most slack time;
d) generating a plurality of time bins, representing a user's available time going forward, for each user in the group;
e) generating a group schedule by the steps of:
i) assigning a weight to each task,
ii) incrementing a load of a user when they receive a task, the user's load being incremented based on the weight of the task, and
iii) assigning each task in the set of tasks successively from the ordered list to users in the group, a task being assigned to the group user who's load does not exceed a threshold relative to other group users and who has the first time bin, or unused portion thereof, large enough to accommodate the task based on the approximate of the time to perform the task and based on the respective schedules of the group users;
f) designating a time bin on the group user's schedule into which a task is fit as unavailable to receive additional tasks;
g) displaying the group schedule of tasks generated in the step e) to the group; and
h) automatically updating the schedule generated in the step e) at least once a day based on fixed appointments or tasks added or deleted by one or more group users.

13. The method of claim 12, further comprising the step of receiving, from one or more users, one or more fixed appointments scheduled for a fixed time and duration, and removing the fixed time and duration from that user's time bins generated in said the step d).

14. The method of claim 12, wherein a user is capable of adding, deleting or changing task and fixed appointment data from any of a variety of locations by accessing a web page on a remote web server.
